(19) United States
(12) Patent Application Publication
(10) Pub. No.: US 2008/0240569 A1
(43) Pub. Date: Oct. 2, 2008

(54) CHARACTER INPUT APPARATUS AND METHOD AND COMPUTER READABLE STORAGE MEDIUM

(75) Inventor: Yojiro Tonouchi, Inagi-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Kabushiki Kaisha Toshiba

(21) Appl. No.: 12/029,348

(22) Filed: Feb. 11, 2008

(30) Foreign Application Priority Data
Mar. 29, 2007 (JP) 2007-087200

(51) Int. Cl. G06K 9/00

(52) U.S. Cl. 382/186

(57) ABSTRACT

A character input apparatus, includes a detection unit configured to detect coordinate data of handwriting, a handwriting display unit configured to sequentially display styled handwriting obtained by styling the handwriting during handwriting operation in accordance with a designated text style and the coordinate data, a recognition unit configured to recognize a character corresponding to the handwriting, and a character display unit configured to display a styled character obtained by styling the recognized character in accordance with the text style and the coordinate data.

### CROSS-REFERENCE TO RELATED APPLICATIONS

This application is based upon and claims the benefit of priority from prior Japanese Patent Application No. 2007-087200, filed Mar. 29, 2007, the entire contents of which are incorporated herein by reference.

### BACKGROUND OF THE INVENTION

1. Field of the Invention

The present invention relates to a character input apparatus and method and a program which recognize a character from the handwriting input to a coordinate input device such as a touch panel or a tablet and display the recognition result on a display screen.

2. Description of the Related Art

Recently, e-mail with styled characters (styled e-mail) has become popular in e-main communication through cellular phones (see, for example, KDDI homepage, [searched Mar. 1, 2007], Internet <URL: http://www.au.kddi.com/email/pastel_mail/index.html>).

Conventionally, it is possible to style and display a character as a recognition result after recognition processing. In this case, only after recognition processing is performed and a character as a recognition result is displayed, the user can check how the character is styled. During handwriting input operation or recognition processing, the user cannot check how the character is finally styled.

In a character input apparatus which inputs a character by handwriting using character recognition, it is preferable to visually check how styles constituting color, size, thickness, font type, and the like are given to an input character during handwriting input operation.

### BRIEF SUMMARY OF THE INVENTION

In accordance with an aspect of the invention, there is provided a character input apparatus, comprising: a detection unit configured to detect coordinate data of handwriting; a handwriting display unit configured to sequentially display styled handwriting obtained by styling the handwriting during handwriting operation in accordance with a designated text style and the coordinate data; a recognition unit configured to recognize a character corresponding to the handwriting; and a character display unit configured to display a styled character obtained by styling the recognized character in accordance with the text style and the coordinate data.

In accordance with another aspect of the invention, there is provided a character input apparatus, comprising: a detection unit configured to detect coordinate data of handwriting; a determination unit configured to determine a text style from the coordinate data; a handwriting display unit configured to sequentially display styled handwriting obtained by styling the handwriting during handwriting operation in accordance with a designated text style and the coordinate data; a recognition unit configured to recognize a character corresponding to the handwriting; and a character display unit configured to display a styled character obtained by styling the recognized character in accordance with the text style and the coordinate data.

### BRIEF DESCRIPTION OF THE SEVERAL VIEWS OF THE DRAWING

FIG. 1 is a block diagram showing a character input apparatus according to the first embodiment;

FIG. 2 is a view for explaining processing performed by a handwriting display unit in FIG. 1 when the text style to be applied is “italic”;

FIG. 3 is a view for explaining processing performed by the handwriting display unit in FIG. 1 when the text style to be applied is “underline”;

FIG. 4 is a view for explaining processing performed by the handwriting display unit in FIG. 1 when the text style to be applied is “bold”;

FIG. 5 is a view for explaining processing performed by the handwriting display unit in FIG. 1 when the text style to be applied is “italic”;

FIG. 6 is a view for explaining processing performed by the handwriting display unit in FIG. 1 when a display size is designated;

FIG. 7 is a view showing a case wherein a styled character is displayed only after recognition;

FIG. 8 is a view showing a case wherein a styled character is displayed during handwriting input operation;

FIG. 9 is a view showing a case wherein a handwriting display position is matched with a character display position;

FIG. 10 is a view showing a case wherein a character display position is matched with a handwriting display position; and

FIG. 11 is a block diagram showing a character input apparatus according to the second embodiment.

### DETAILED DESCRIPTION OF THE INVENTION

A character input apparatus and method and a program according to embodiments of the present invention will be described below with reference to the views of the accompanying drawing. Note that the same reference numerals denote parts which operate in the same manner in the following embodiments, and a repetitive description will be omitted.

The character input apparatus and method and the program according to the embodiments allow to input a styled character while checking styled handwriting.

The character input apparatus and method and the program according to the embodiments sequentially display handwriting on the screen in the same form as that of a text styling technique (character color, font type, character size, character thickness [or bold or not], underline or not, blinking or not, italic or not, or the like) so as to allow to check the text styling technique even during handwriting input operation or recognition processing.

### First Embodiment

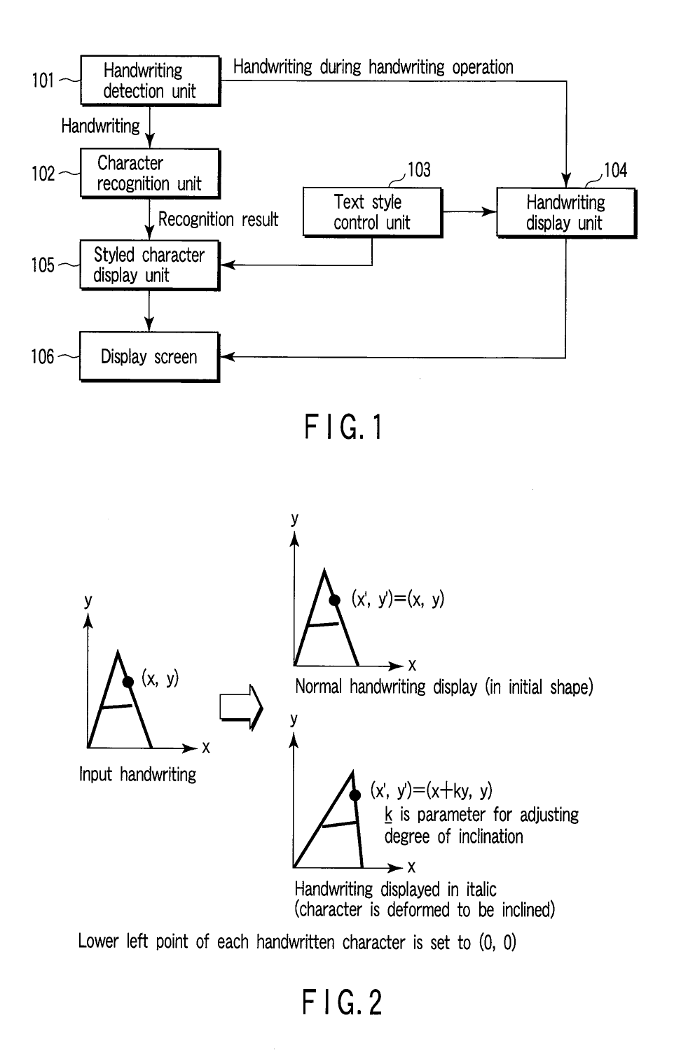

The character input apparatus of this embodiment will be described with reference to FIG. 1.

The character input apparatus of this embodiment includes a handwriting detection unit 101, character recognition unit 102, text style control unit 103, handwriting display unit 104, styled character display unit 105, and display screen 106.

The handwriting detection unit 101 detects whether the pen or the finger is in contact with a sensor, and acquires the coordinate data of handwriting which the user performs with the pen, finger, or the like. The handwriting detection unit 101 accepts a coordinate string acquired during contact with the sensor as one-stroke handwriting data.

For example, the handwriting data of one character comprising n strokes is expressed by the following time series data:
first stroke: (X[1][1], Y[1][1]), (X[1][2], Y[1][2]), . . . , (X[1][N[1]], Y[1][N[1]])
second stroke: (X[2][1], Y[2][1]), (X[2][2], Y[2][2]), . . . , (X[2][N[2]], Y[2][N[2]])
. . .
nth stroke: (X[n][1], Y[n][1]), (X[n][2], Y[n][2]), . . . , (X[n][N[n]], Y[n][N[n]])
   where X[i][j] and Y[i][j] respectively represent the jth x- and y-coordinates of the ith stroke, and N[i] represents the number of dots of the ith stroke.

If a writing pressure can be acquired at the same time, the handwriting data of one character comprising n strokes is expressed as follows:
first stroke: (X[1][1], Y[1][1], Z[1][1]), . . . , (X[1][N[1]], Y[1][N[1], Z[1][N[1]])
. . .
nth stroke: (X[n][1], Y[n][1], Z[n][1]), . . . , (X[n][N[n]], Y[n][N[n]], Z[n][N[n]])
   where Z[i][j] represents the jth writing pressure of the ith stroke.

The handwriting detection unit 101 also detects the width of handwriting. In this case, the ith stroke includes a plurality of jth x-coordinates and a plurality of jth y-coordinates. That is, for example, as the numbers of jth x- and y-coordinates of the ith stroke increase, the width of the handwriting increases.

The character recognition unit 102 recognizes a character. For example, every time the character recognition unit 102 acquires handwriting data, the unit obtains a most likelihood, optimal character string from handwriting data input so far by using a character structure dictionary (not shown) and an inter-character structure dictionary (not shown) on the basis of the handwritten shapes input so far and the positional relationship between the handwritten characters. The character structure dictionary is a dictionary in which data (character structure dictionary information) expressing the structure of each character to be recognized, i.e., feature information such as the shape of handwriting forming each character and the positional relationship (structure) between handwritten characters, is registered. The inter-character structure dictionary is a dictionary in which data (inter-character dictionary information) expressing the structural relationship between each pair of characters, of a plurality of characters registered in the character structure dictionary, which are consecutively handwritten is registered. Note, however, that other techniques can be used as long as characters can be recognized.

The text style control unit 103 determines the following text styles in accordance with instructions from the user:
character color
change of form of character font (italic or not, underlined or not, bold or not, or the like)
blinking
display size of character
switching between font display and handwriting display
alternate display of font and handwriting
   A technique for designating text style is not limited to designation from the user.

The handwriting display unit 104 sequentially displays, based on input data, handwriting which is being written on the display screen 106 by the display technique determined by the text style control unit 103. The handwriting display unit 104 displays a set of line segments obtained by combining a set of coordinates as handwriting data for each stroke in accordance with the text style designated by the text style control unit 103. Note that depending on the text style, it is necessary to change the handwriting size, shape, display position, and handwriting display technique.

The styled character display unit 105 determines a display technique such as a font type, font form, size, and display color in accordance with the styling technique determined by the text style control unit 103, and displays the resultant character on the display screen 106.

The display operation of the handwriting display unit 104 will be described below.

When a character color is designated, the handwriting display unit 104 sets the color of a line segment set to the designated character color.

If the change of the form of a character font is designated, the processing to be performed differs depending on the change destination font form. The following are several examples of processing to be performed.

### <Italic>

When the character font is to be changed to italic, the handwriting display unit 104 displays the handwriting data upon linear transformation of the coordinates of the data, as shown in FIG. 2. Letting (x, y) be the coordinates of a given point of the input handwriting when the lower left point of the input handwriting is set to (0, 0), the handwriting display unit 104 performs transformation of (x, y)→(x+ky, y), where k is a real number as a parameter for adjusting the degree of an inclination. As the number k increases, the inclination increases.

### <Underline>

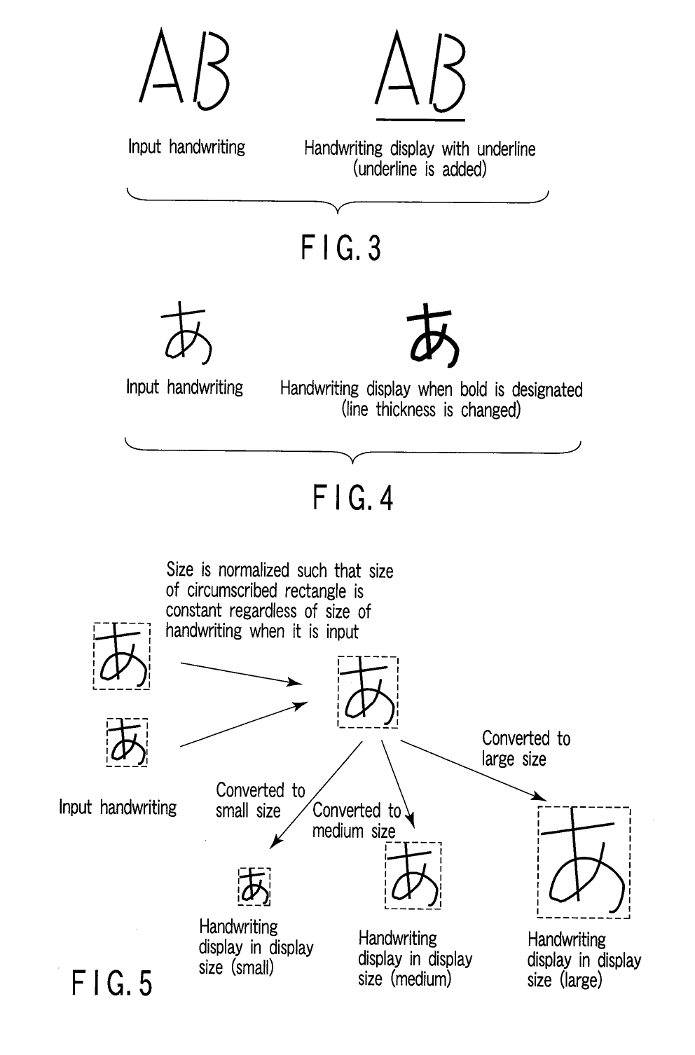

As shown in FIG. 3, when an underline is to be added to the handwriting, the handwriting display unit 104 displays the handwriting upon adding a line to its lower side. The handwriting display unit 104 refers to the coordinates of lowermost portions of the handwriting data to specify the position of a line segment such that the position is located slightly below the position indicated by the coordinates and the line segment becomes parallel to a line connecting the coordinates of a plurality of lowermost portions of the handwriting data, and displays the line segment as an underline.

### <Bold>

When the handwriting is to be changed to bold, the line segment set to be displayed as handwriting is thickened, as shown in FIG. 4. The handwriting display unit 104 detects, for example, the coordinates of the handwriting from the input handwriting data, and thickens the input handwriting by handling coordinates around the detected coordinates as handwriting data. The handwriting display unit 104 can adjust the thickness of the handwriting to a certain thickness by determining the specific range of distance from the coordinates of the input handwriting data within which coordinates are handled as handwriting data.

### <Blinking>

When the handwriting is to be made to blink, the handwriting is alternately displayed and not displayed at predetermined time intervals. For example, the handwriting display unit 104 detects handwriting data to be made to blink, acquires the time from a timer (not shown) which can measure the time, and alternately sets the handwriting data in the display state and the non-display state at predetermined time intervals.

### <Display Size>

When a display size is designated, as shown in FIG. 5, the input one-character handwriting is temporally normalized to a predetermined size to be independent of the size of the input handwriting, and the handwriting data is then converted into data with the designated size. For example, the handwriting display unit 104 detects the coordinates of input one-character handwriting data, calculates the area of the portion where the coordinates are distributed, and enlarges/reduces the handwriting so as set the area to a predetermined size. The handwriting display unit 104 then enlarges or reduces the handwriting normalized to a large, medium, or small size determined by the area of the portion where the character is displayed.

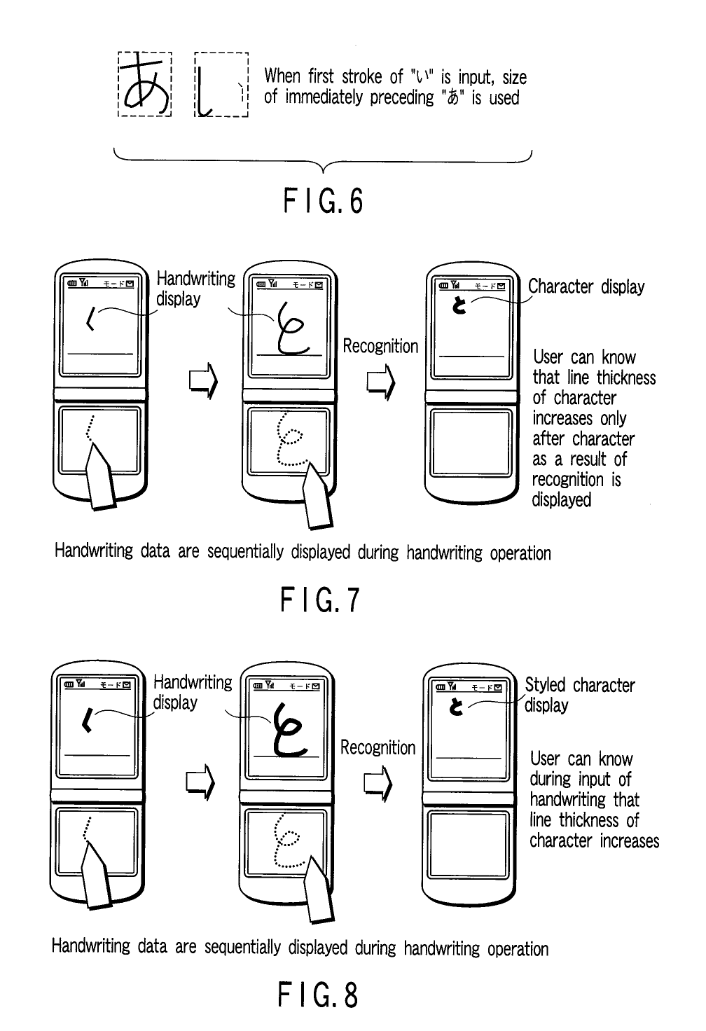

In practice, however, since the size of an input character cannot be determined unless one-character data is input, it suffices to substitutively use the size of an already input character. For example, as shown in FIG. 6, when the first stroke is input, the input data is normalized according to the size of the immediately preceding character.

Switching between font display and handwriting display and alternate display of a font and handwriting will be described next.

### <Font Display and Handwriting Display>

When font display is to be performed, the character recognition unit 102 recognizes the font based on handwriting, and displays the font recognized by the styled character display unit 105 upon converting the recognized font into a form corresponding to the recognized font. When handwriting display is to be performed, the character recognition unit 102 recognizes the font based by the character recognition unit 102, and the handwriting display unit 104 displays the shape of the handwriting without changing the handwriting. That is, in the case of handwriting display, the handwriting is displayed without any change. When font display is switched to handwriting display, the handwriting display unit 104 displays the handwriting instead of the font at the position where the font is displayed and in the same size as that of the font.

### <Alternate Display of Font and Handwriting>

When a font and handwriting are to be alternately displayed, the handwriting display unit 104 alternately displays the font and the handwriting at predetermined time intervals at the position where the font is displayed by the styled character display unit 105 and in the same size as that of the font.

A difference between an example of display by the conventional character input apparatus and an example of display by the character input apparatus of this embodiment will be described with reference to FIGS. 7 and 8. A case wherein a character is styled as a bold character will be described below.

In the conventional character input apparatus, as shown in FIG. 7, even if handwriting data is sequentially displayed during handwriting operation, no style is reflected on the display screen unless character recognition of the handwriting is complete. That is, the character “ [symbol] ” in bold is displayed on the display screen only after character recognition.

On the other hand, according to the character input apparatus of this embodiment, as shown in FIG. 8, the handwriting display unit 104 acquires the style designated by the text style control unit 103, and can display handwriting in bold on the display screen 106 even if the handwriting is being performed.

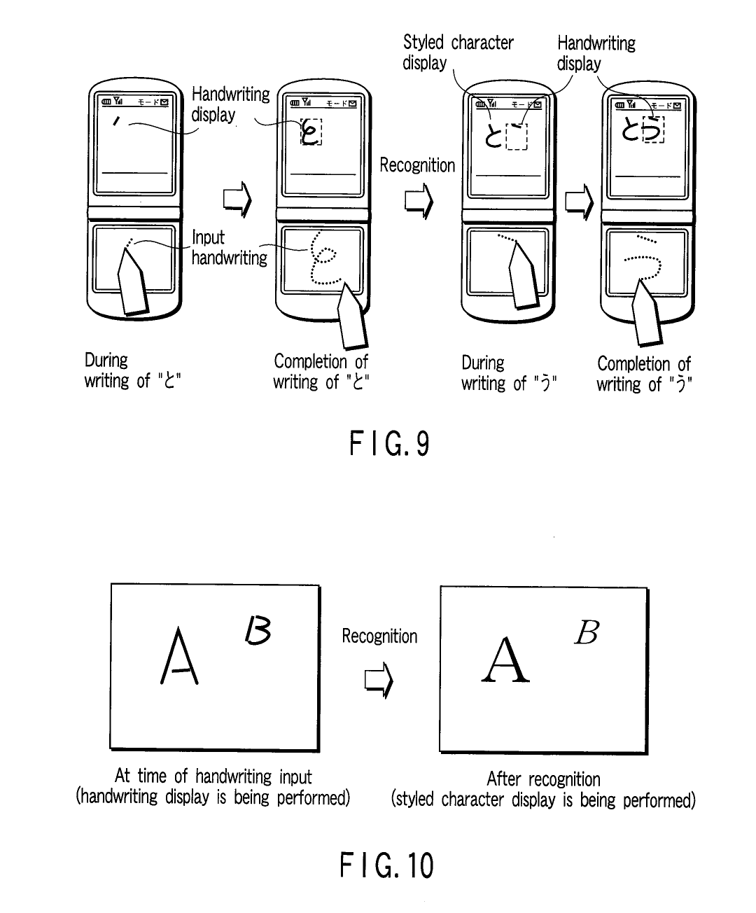

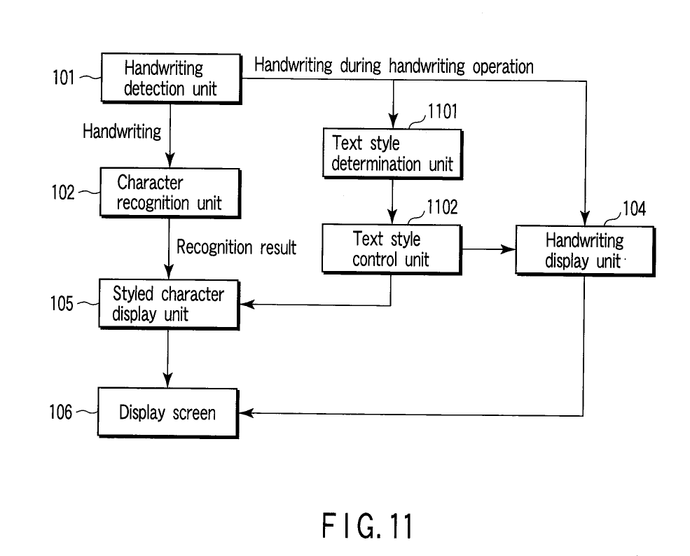

The display position of handwriting by the handwriting display unit 104 and the display position of a styled character by the styled character display unit 105 will be described next with reference to FIGS. 9 and 10. FIGS. 9 and 10 each show a case wherein the display position of handwriting coincides with the display position of a character.

Referring to FIG. 9, the handwriting display unit 104 displays handwriting at the same position as the display position of a styled character by the styled character display unit 105. The handwriting display unit 104 obtains in advance the position (the cursor position in general) where the next character is to be displayed and the size of the character, and displays the handwriting at the position and in the size.

Referring to FIG. 10, the styled character display unit 105 displays a styled character at the same position as the position at which the handwriting display unit 104 displays the handwriting. This technique is suitable for a display-integrated character input apparatus (a screen on which a handwriting detection unit detects handwriting overlaps a display screen).

According to the first embodiment described above, even while recognition processing is being performed during handwriting input operation by the user, handwriting data is sequentially displayed on the screen with the text style designated by the user, thereby allowing the user to input a character with the style while checking handwriting with the style.

### Second Embodiment

A character input apparatus of this embodiment will be described with reference to FIG. 11.

The character input apparatus of this embodiment includes a text style determination unit 1101 and a text style control unit 1102 in place of the text style control unit 103 of the first embodiment. In the first embodiment, a text style is determined in accordance with an external instruction, e.g., an instruction from the user. In contrast, in the second embodiment, the text style determination unit 1101 determines a text style. The text style control unit 1102 gives instructions to a handwriting display unit 104 and a styled character display unit 105 so as to perform the text styling determined by the text style determination unit 1101. The handwriting display unit 104 may display input handwriting in its initial shape without any change. The handwriting display unit 104 displays input handwriting by the technique designated by the text style control unit 1102 with respect to the display color, line type, and line thickness of the handwriting.

The text style determination unit 1101 determines a text styling technique on the basis of handwriting data from a handwriting detection unit 101 during handwriting operation.

### <Bold>

A case wherein the text style determination unit 1101 determines a styling technique as bold from handwriting during handwriting operation. The text style determination unit 1101 instructs the handwriting display unit 104 to display in bold, for example, a character, of handwriting data, whose data exhibits a writing pressure equal to or more than a threshold. The text style determination unit 1101 can also instruct the handwriting display unit 104 to continuously change the thickness of a line in accordance with writing pressure data. For example, the text style determination unit 1101 instructs the handwriting display unit 104 to increase the thickness of a line as the writing pressure indicated by writing pressure data increases. This allows to display a line segment having both a thick portion and a thin portion.

### <Italic>

A case wherein the text style determination unit 1101 determines from handwriting during handwriting operation that the styling technique is “italic”. The text style determination unit 1101 refers to, for example, a database (not shown) including a template for italic and compares handwriting with each template to detect whether there is a corresponding template. If there is a template, the text style determination unit 1101 determines that the handwriting is italic and instructs the handwriting display unit 104 to display the italic character.

### <Underline>

A case wherein the text style determination unit 1101 determines from handwriting during handwriting operation that the styling technique is “underline”. The text style determination unit 1101 recognizes a long continuous line as an underline by using projection or the like in accordance with the direction of a character row represented by handwriting data during handwriting operation which is detected by the handwriting detection unit 101, and instructs the handwriting display unit 104 to add an underline. Knowing how much an underline is separated from a line makes it easy to obtain the start and end points of the underline afterward. Double underlines can also be extracted by basically the same technique.

### <Wavy Line/Broken Line>

A case wherein the text style determination unit 1101 determines from handwriting during handwriting operation that the styling technique is “wavy line/broken line” will be described. After determining the rough positions of wavy lines/broken lines by the same technique as that for an underline, the text style determination unit 1101 determines the positions of wavy lines/broken lines by matching them with a plurality of wavy line patterns and a plurality of broken line patterns which are prepared in advance.

In the case of a broken line, when labeling a given portion, the text style determination unit 1101 can specify the portion as a broken line, if many fine labels are produced. In this case, the text style determination unit 1101 specifies the type of broken line depending on the size and number of labels at the corresponding portion, and instructs the handwriting display unit 104 to add the broken line.

In the case of a wavy line, when performing labeling a given portion, the text style determination unit 1101 can specify the portion as a wavy line, if a long label is produced in the horizontal direction and the number of black pixels is smaller than the total number of labels. The text style determination unit 1101 specifies the type of wavy line by horizontally searching a portion at a height ½ that of the line and counting the number of times black and white pixels are inverted up to the end of the search, and instructs the handwriting display unit 104 to add the wavy line.

Note that a display-integrated character input apparatus may display handwriting at the input position of the handwriting without changing the position.

The second embodiment described above determines the text style designated by the character input apparatus even while the user is inputting handwriting or recognition processing is being performed, and sequentially displays the handwriting with the text style on the screen, thereby allowing the user to input a styled character while checking the styled handwriting.

According to the embodiments described above, displaying handwriting in real time in the same form as that of a text style allows the user to input handwriting while seeing the style of the displayed handwriting. This allows the user to visually check, in real time, how a character written by the user is styled, during handwriting operation.

The flow charts of the embodiments illustrate methods and systems according to the embodiments of the invention. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block of blocks. The computer program instructions may also be loaded onto a computer or other programmable apparatus to cause a series of operational steps to be performed on the computer or other programmable apparatus to produce a computer programmable apparatus provide steps for implementing the functions specified in the flowchart block or blocks.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A character input apparatus, comprising:
a detection unit configured to detect coordinate data of handwriting;
a handwriting display unit configured to sequentially display styled handwriting obtained by styling the handwriting during handwriting operation in accordance with a designated text style and the coordinate data;
a recognition unit configured to recognize a character corresponding to the handwriting; and
a character display unit configured to display a styled character obtained by styling the recognized character in accordance with the text style and the coordinate data.

2. The apparatus according to claim 1, wherein the detection unit further detects writing pressure data of the handwriting.

3. The apparatus according to claim 1, wherein the character display unit displays the styled character at the same position as a display position of the handwriting displayed by the handwriting display unit.

4. The apparatus according to claim 1, wherein when receiving an instruction associated with a style which instructs to directly display handwriting without displaying a recognition result in a character font, the character display unit directly displays the handwriting.

5. The apparatus according to claim 1, wherein when receiving an instruction to alternately performing operation of directly displaying handwriting without displaying a recognition result in a character font and operation of displaying the recognition result, the character display unit alternately performs the operation of directly displaying handwriting without displaying the recognition result and the operation of displaying the recognition result.

6. A character input apparatus, comprising:
a detection unit configured to detect coordinate data of handwriting;
a determination unit configured to determine a text style from the coordinate data;
a handwriting display unit configured to sequentially display styled handwriting obtained by styling the handwriting during handwriting operation in accordance with a designated text style and the coordinate data;
a recognition unit configured to recognize a character corresponding to the handwriting; and
a character display unit configured to display a styled character obtained by styling the recognized character in accordance with the text style and the coordinate data.

7. The apparatus according to claim 6, wherein the detection unit further detects writing pressure data of the handwriting, and the determination unit determines a text style from the coordinate data and the writing pressure data.

8. The apparatus according to claim 6, wherein the character display unit displays the styled character at the same position as a display position of the handwriting displayed by the handwriting display unit.

9. The apparatus according to claim 6, wherein when receiving an instruction associated with a style which instructs to directly display handwriting without displaying a recognition result in a character font, the character display unit directly displays the handwriting.

10. The apparatus according to claim 6, wherein when receiving an instruction to alternately performing operation of directly displaying handwriting without displaying a recognition result in a character font and operation of displaying the recognition result, the character display unit alternately performs the operation of directly displaying handwriting without displaying the recognition result and the operation of displaying the recognition result.

11. A character input method, comprising:
detecting coordinate data of handwriting;
sequentially displaying styled handwriting obtained by styling the handwriting during handwriting operation in accordance with a designated text style and the coordinate data;
recognizing a character corresponding to the handwriting; and
displaying a styled character obtained by styling the recognized character in accordance with the text style and the coordinate data.

12. A computer readable storage medium storing instructions of a computer program which when executed by a computer results in performance of steps comprising:
detecting coordinate data of handwriting;
sequentially displaying styled handwriting obtained by styling the handwriting during handwriting operation in accordance with a designated text style and the coordinate data;
recognizing a character corresponding to the handwriting; and
displaying a styled character obtained by styling the recognized character in accordance with the text style and the coordinate data.

13. A computer readable storage medium storing instructions of a computer program which when executed by a computer results in performance of steps comprising:
detecting coordinate data of handwriting;
determining a text style from the coordinate data;
sequentially displaying styled handwriting obtained by styling the handwriting during handwriting operation in accordance with a designated text style and the coordinate data;
recognizing a character corresponding to the handwriting; and
displaying a styled character obtained by styling the recognized character in accordance with the text style and the coordinate data.
